(19) United States
(12) Patent Application Publication
(10) Pub. No.: US 2002/0091554 A1
(43) Pub. Date: Jul. 11, 2002

(54) Methods and apparatus for electronically storing travel agents coupons

(76) Inventor: Rodger Burrows, Plantation, FL (US)

Correspondence Address: Richard M. Saccocio, Richard M. Saccocio, P.A., 100 Southeast 12th Street, Ft. Lauderdale, FL, 33316, US

(21) Appl. No.: 09/910,654

(22) Filed: Jul. 20, 2001

Related U.S. Application Data
(60) Provisional application No. 60/260,412, filed on Jan. 9, 2001.

(51) Int. Cl. G06F 17/60

(52) U.S. Cl. 705/5; 705/14

(57) ABSTRACT

Methods and apparatus provide for the electronic storage and retrieval of airline ticket agency data simultaneously with the generation of one or more airline tickets. The inventive methods and apparatus eliminate the prior art requirement of printing and storing hard copies of agent coupons.

### CROSS REFERENCE TO RELATED APPLICATIONS

This application is related to U.S. provisional application Serial No. 60/260,412 filed Jan. 9, 2001.

### BACKGROUND OF THE INVENTION

1. Field of the Invention

This invention relates in general to the field of electronic storage of data and in particular to methods and apparatus for electronically storing agent coupon data associated with airline tickets procured through a travel agent.

2. Description of the Prior Art

Most, if not all airline ticket service organizations or travel agents provide the service of reserving and issuing airline tickets to travelers. An airline agency known as the Airline Recording Corporation (ARC) requires travel agencies to retain physical copies of “agent coupons” for a minimum of two years from the date of issuance of an airline ticket. In general, an agent coupon contains data associated with an issued airline ticket such as the name and address of the passenger, travel dates, the name of the airline, departure and arrival locations and time, fares charged for the ticket, and other like data. The primary reason for the ARC requirement to have airline ticket agencies retain hard copies of the agent coupons is to have a complete record of the ticket transaction should a dispute arise, for example, regarding a refund, when a ticket exchange is necessary or any other like reason. The agent coupons are not, therefore, generally accessed by the airline ticket agencies on a daily basis but rather only a sporadic or a necessary basis. Still, the ARC requirement inherently necessitates that the airline ticket agencies provide for storage of the hard copies of the coupons. And, in the travel industry, it is common for the agencies to keep the agent coupons for a period of time longer than the required minimum of two years. Such self-imposed requirements mean that the travel agents must provide for long-term storage of the coupons.

Because of the nature of the required and self-imposed storage of the agent coupons in conjunction with the “access as necessary” of the coupons, the physical storage of the coupons pose a number of unique problems. For example, a storage facility or storage space is required. If the storage space is within the offices of the service agency, the agent coupon records not only consume valuable office space that otherwise could be used to generate fees, but the physical presence of the coupons themselves often hinders the office personnel in carrying out their everyday duties. Accordingly, in order to minimize the storage space taken up by the agent coupons, and because of the card-like nature of the coupons, the coupons are usually stored, one behind the other, in boxes that are sized to accommodate the coupons. The boxes themselves are then stacked on top of each other in chronological order with the most recent coupons being located on the upper levels. Then, accordingly, when a particular coupon is to be retrieved, the boxes must be un-stacked to gain access to the box containing the particular coupon. After the coupon is retrieved and processed, the procedure is reversed in order to reorganize the stored coupons. obviously, such a procedure is time consuming, expensive, and inconvenient.

If a separate off-site storage facility is used to store the agent coupons, the rental space will be less costly than office space but then other inconvenient and expensive factors become involved. For example, the retrieval effort is even more time consuming and inconvenient in that office personnel must travel to and from the off-site storage facility. There is still then the problem of having to un-stack the boxes, retrieve the particular coupon, and then re-stack the boxes. It is axiomatic that the larger the travel agency, the more these problems are exacerbated.

What is needed are apparatus and methods that allow for the ease of maintaining the storage of travel agency agent coupons, allow for ease of retrieval, eliminate the need for a separate storage space, provide for secure storage, and are cost effective. The present invention accomplishes these objectives.

### SUMMARY OF THE INVENTION

The above-stated objects as well as other objects which, although not specifically stated, but are intended to be included within the scope the present invention, are accomplished by the present invention and will become apparent from the hereinafter set forth Detailed Description of the Invention, Drawings, and Claims appended herewith. The present invention accomplishes these objectives by providing methods and apparatus for electronic storage of agent coupons in a most effective manner.

In one embodiment of the present invention, electronic data storage apparatus is electronically connected to an airline ticket reservation arrangement with the latter being located in the office of an airline ticket agency. As an airline ticket is being generated by the reservation system, the agent coupon data is being transmitted simultaneously to the electronic storage apparatus. Alternatively, the coupon data can be transmitted to the electronic storage apparatus in a batch file arrangement. The transmitted data is stored on a known type of storage apparatus such as a hard drive and on a CD ROM disk. The stored data is retrievable from a computer workstation that can access the storage apparatus by a serial connection, a modem connection or an intranet/internet network connection. Once the particular coupon data is accessed, a printer is used to print out the stored data, which includes all of the data normally associated with an agent coupon. The reservation system, the storage apparatus, the retrieval apparatus, and the printer can each be located at the same site, or each can be located at a different site, or each can be located at any combination thereof. Any site can be activated by an intranet network connection or by an internet network connection using an appropriate internet browser.

In accordance with the above, there has been summarized the more important features of the present invention in order that the detailed description of the invention as it appears in the below detailed description of the same, may be better understood.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a schematic block flow diagram of one embodiment of the present invention illustrating the apparatus and methods as contemplated by the present invention;

FIG. 2 is a schematic block flow diagram of the basic apparatus of FIG. 1 as applied to a computer network arrangement.

### DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functioning details disclosed herein are not to be interpreted as limiting, but merely as a basis for the claims and as a representative basis for teaching one skilled in the art to variously employ the present invention in virtually any appropriately detailed structure. Additionally, the words and phrases used herein are intended to better enable a person to understand the invention and therefore, such words and phrases are not to be interpreted as limiting the invention.

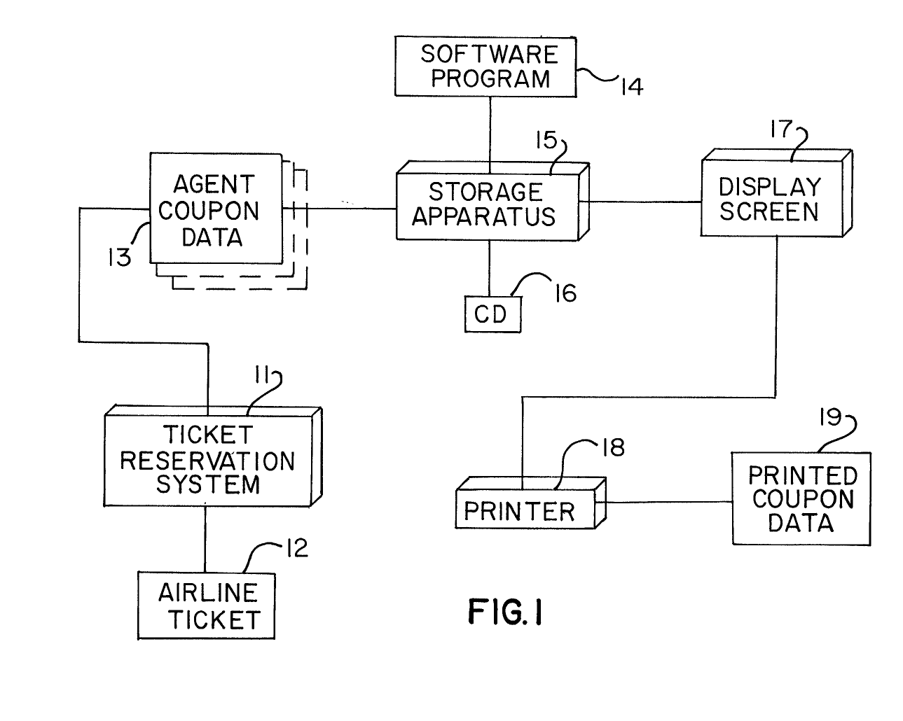

Reference is now made to the drawings, wherein like the characteristics and features of the present invention shown in the various figures are designated by the same reference numerals. FIG. 1 illustrates one embodiment of the apparatus and method of the present invention. A typical airline ticket reservation system 11 is electronically connected to appropriate electronic data storage apparatus 15 that can but not necessarily comprise a computer having a hard drive and CD-ROM capability. An appropriate software program 14 is loaded into the data storage apparatus 15 that enables the airline ticket reservation system to electronically communicate with the data storage apparatus 15 as more fully explained hereinafter. The reservation system 11 can comprise the electronic apparatus that an agency normally employs to record and generate an airline ticket and the prior art agent coupon. The electronic connection can be a serial connection, a modem connection, or an intranet/internet network connection. Thus, the electronic storage apparatus 15 can be on the site of the reservation system 11 or can be remotely located therefrom. In accordance with the software program 14, agent coupon data 13 is simultaneously generated along with an airline ticket 12. The data 13 generated by the reservation system 11 can comprise all of the data entered onto an airline ticket, including but not limited, to the data normally associated with an agent coupon as well as any other data deemed appropriate. The data 13 to be stored can be transmitted for example, in image format, accounting record format, or data file format. The data 13 can be transmitted to the storage apparatus 15 at the time each airline ticket 12 is created. The data and information can be temporarily stored within the reservation system 11 and upon the generation of a plurality of tickets, the temporarily stored data can be transmitted in a batch file format to the storage apparatus 15. The transmitted data 15 is stored in the storage apparatus 13 under, for example, a file designation that can include the ticket number, the passenger's name, the passenger's record locator or number, and the airline ticket agency's or the travel agent's information. The stored file is then moved to, for example, to a primary directory comprising the Airline Reporting Corporation's number and a sub-directory created by calculating the Sunday following the date of issue of the ticket. Thus, for example, the directory structure can comprise: ARC number (directory)/sales period ending date (directory), ticket number, passenger name, and record locator (image files).

On a continual or on a nightly basis, the data 13 stored in storage apparatus 15 can be transferred to files named, for example, “DATE.tgz”. The “tgz” files can be written to a Random Operating Memory (ROM) compact disk (CD) 16. It is preferred at this time, to record the sales period ending date and the issue date for which this data belongs, into a reference file for future lookup and or retrieval purposes. The software program 14 incorporated in the storage apparatus 15 continuously checks and verifies the available space on the CD 16, and when the CD 16 is full, a message is sent advising an operator to change to a new CD 16. Each CD 16 can have a header file identifier for identification purposes. Alternatively, the data can be simultaneously stored on both a hard disk and a CD 16.

When a dispute, refund, or exchange occurs, the coupon data 13 stored in the storage apparatus 15 and the CD-ROM disk 16 can be retrieved as follows. The operator activates a retrieval portion of the software program 14 that is loaded into the storage apparatus 15 and inputs information which allows for the retrieval of a particular coupon data, including but not limited to, for example, the agency code number (ARC number), sales period ending date, the ticket number, the record locator and the passenger's name. The storage apparatus 15 searches its hard drive for the file. If the file is not available, because of a system crash or because the file has been purged from the computer, an operator is directed to load the appropriate CD 16 containing the desired data. Upon retrieval of the desired data, a display screen 17 associated with the storage apparatus 15 displays an image consistent with the image of a physical coupon or simply displays the data 13 in any other appropriate format. It is then a simple matter for the operator to command the storage apparatus 15 to print an image of the coupon being retrieved. In this regard, an appropriate printer 18, is electronically connected to the storage apparatus 15. The printed image 19 can be on plain paper in the coupon format, or can be printed on actual ARC approved ticket coupon stock, or can be printed in any appropriate data format.

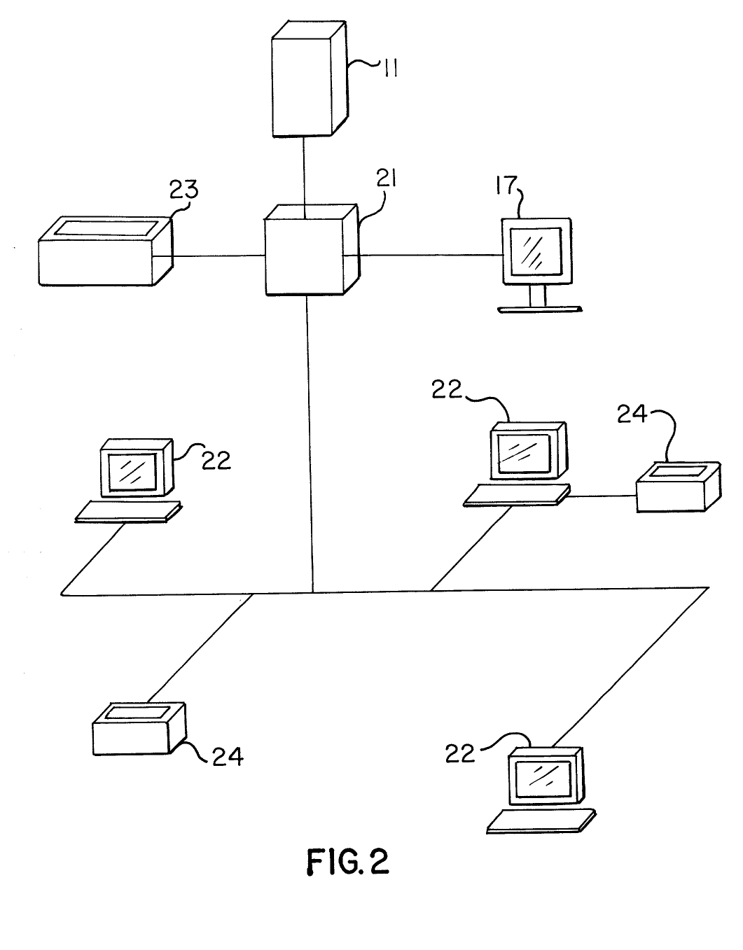

FIG. 2 illustrates the apparatus and methods of FIG. 1 as applied to a networked retrieval arrangement. In FIG. 2, a central storage computer 21 is used as the storage apparatus. As in the previous embodiment of FIG. 1, the central storage computer 21 is arranged to receive ticket information from a reservation system (CRS) 11 through an electronic data connection. A plurality of computer equipped workstations 22 are network connected to the central storage computer 21. A central coupon data printer 23 is connected to the central storage computer 21. One or more additional coupon printers 24 can be connected to the networked stations 22 in an appropriate manner consistent with the physical location and arrangement of the workstations 22.

The inventive methods include the storage and retrieval of an electronic agent coupon as follows. The reservation system 11 of a travel agent is electronically connected to an appropriate electronic storage and retrieval system 15 that is provided with appropriate software 14. Upon generating an airline ticket, the reservation system creates a file or document that contains all of the data associated with a prior art agent coupon. For example, such data includes but is not limited to the ticket number, the passenger's name and address, the passenger record number, the flight information, the date of the ticket, and the sales period ending date. The agent coupon data is given an identifier designation that will allow subsequent ease of retrieval. For example, the identifier can comprise the ticket number. The agent coupon data is then stored in a directory under the identifying designation as provided for by the software. The identifier designation can further include the passenger's name, and/or the passenger record number, and/or the sales period ending date, any one or all of which can be used to store the agent coupon data in a primary directory and sub-directories. For example, four separate primary directories can exist corresponding to the above identifiers, with each primary directory having three separate sub-directories comprising the other identifiers, all of which are automatically created by the software. or, a single primary directory can be used that is indexed by the passenger's record number. In this manner, any one or all of the identifiers can be used to subsequently retrieve the coupon data.

In order to retrieve a particular agent coupon's data, the available identifier or identifiers are input to a retrieval screen brought up by an appropriate instruction to the software. The software then searches its data banks or directories and displays the directory or identifies the CD containing the identifier. If more than one identifier is input, the software again brings up the directory or identifies the CD containing the identifiers. An operator can then select the appropriate identifier which then brings up the coupon data from the hard drive of the storage apparatus 13, or the operator loads the identified CD which then brings up the data. Alternatively, once the identifier or identifiers are input, the software searches the internal or external data banks and directories and directly brings up the coupon data associated with the same. The operator then prints the coupon data onto a paper copy.

The above storage and retrieval apparatus and methods utilize the above described software program, which allows for the coupon information to be stored and retrieved in the manner described. It is to be understood that the indexing and directories, above described, can be varied without departing from the scope of the present invention.

The described invention therefore provides methods, software and apparatus to electronically store agent coupon information and/or data which is generated when an airline ticket is prepared or when a batch data file is received, and then retrieve the coupon data at a later date and print a document which contains all of the coupon data and/or information. In the embodiments, above described, the initiation and activation of the retrieval method can be accomplished on or off the site of the storage apparatus, by for example the use of an internet/intranet connection using an appropriate internet browser and/or Adobe Acrobat Reader.

While the invention has been described, disclosed, illustrated and shown in certain terms or certain embodiments or modifications which it has assumed in practice, the scope of the invention is not intended to be nor should it be deemed to be limited thereby and such other modifications or embodiments as may be suggested by the teachings herein are particularly reserved especially as they fall within the breath and scope of the drawings and description provided herein.

What is claimed is:

1. A method for electronically generating, storing, and retrieving airline ticket agency coupon data, comprising the steps of:
generating agent coupon data simultaneously with the printing of an airline ticket;
transmitting and storing said agent coupon data electronically to and in data storage apparatus;
providing each agent coupon data with an identifier;
storing said agent coupon data in a director/directory/image file arrangement; and
retrieving said electronically stored agent coupon data and printing the same.

2. The method of claim 1, including the step of storing said agent coupon data on a compact disk.

3. The method of claim 1, including the step of storing said agent coupon data on a hard drive.

4. The method of claim 1, including the step of transmitting and storing a plurality of agent coupon data in a batch file format.

5. The method of claim 1, including the step of generating said agent coupon data by airline ticket reservation apparatus.

6. The method of claim 5, including the step of serially connecting said reservation apparatus to said data storage apparatus.

7. The method of claim 5, including the step of connecting said reservation apparatus to said data storage apparatus by a modem.

8. The method of claim 5, including the step of internet connecting said reservation apparatus to said data storage apparatus.

9. The method of claim 5, including the step of intranet connecting said reservation apparatus to said data storage apparatus.

10. The method of claim 1, wherein said identifier comprises an ARC number.

11. The method of claim 10, wherein said identifier includes a sales period ending date.

12. The method of claim 11, wherein said identifier includes a ticket number.

13. The method of claim 12, wherein said identifier includes a passenger's name.

14. The method of claim 13, wherein said identifier includes a record locator.

15. Apparatus adapted to generate, transmit, store, and retrieve airline agent coupon data, comprising:
airline ticket reservation apparatus; and
data storage apparatus comprising:
a computer having a hard drive, said data storage apparatus being electronically connected to said reservation system;
a software program means loaded in said computer for generating agent coupon data simultaneously with generation of an airline ticket, transmitting said agent coupon data to said computer, storing and retrieving said agent coupon data on memory storage apparatus connected to said computer; and
said computer having means associated therewith for displaying said stored agent coupon data.

16. The apparatus of claim 15, including printing means connected to said computer for printing said stored and retrieved agent coupon data.

17. The apparatus of claim 16, wherein said software program means further includes means for identifying each generated agent coupon data.

18. The apparatus of claim 17, wherein said software program means further includes means for filing each generated agent coupon data in accordance with said identifier means.
